(19) United States
(12) Patent Application Publication
(10) Pub. No.: US 2013/0289836 A1
(43) Pub. Date: Oct. 31, 2013

(54) TRANSMISSION CONTROL SYSTEM

(71) Applicant: Wei Li, Peoria, IL (US)

(72) Inventor: Wei Li, Peoria, IL (US)

(21) Appl. No.: 13/458,561

(22) Filed: Apr. 27, 2012

(51) Int. Cl. F16H 59/14

(52) U.S. Cl. 701/51

(57) ABSTRACT

A method of controlling a transmission associated with a machine includes determining a torque demand associated with a parasitic load, the parasitic load receiving power from a power source of the machine via the transmission. The method also includes converting the torque demand into a corresponding torque request using a first neural network associated with a control system of the machine. The torque demand is an input of the first neural network and the torque request is an output of the first neural network. The method further includes directing the power source to provide torque to the transmission substantially equal to the torque request.

### TECHNICAL FIELD

This disclosure relates generally to a control system and, more particularly, to a system and method of controlling a transmission.

### BACKGROUND

Machines such as, for example, wheel loaders, track type tractors, and other types of heavy machinery can be used for a variety of tasks. These machines include a power source, which may be, for example, an engine, such as a diesel engine, gasoline engine, or natural gas engine that provides the power required to complete such tasks. To effectively maneuver the machines during performance of such tasks, the machines also include a transmission that is capable of transmitting power generated by the engine to various drivetrain components of the machines over a wide range of conditions.

For example, such machines commonly use a continuously variable transmission (“CVT”) to direct engine torque to traction devices, such as wheels or tracks, that propel the machine. A CVT is capable of providing an output torque to such components, at any speed within its operating range, by continuously changing the ratio of the transmission. During some operations, the engine and/or the CVT may also be used to assist in braking the machine. For example, during operations in which the machine is required to change travel directions at relatively high load, the engine and the CVT may be configured to provide a retarding torque to the traction devices in order to stop the machine.

However, due to the complexity of the CVT, it can be difficult to provide the proper amount of output torque to the traction devices. For example, various controllers associated with the CVT may receive torque demands from the traction devices to facilitate movement of the machine. The controller must then convert the torque demands received from the traction devices (i.e., transmission torque output requests) into corresponding torque requests (i.e., engine torque output requests) that can be sent to the engine. Since the torque and/or power transfer from the engine through the CVT is highly non-linear, however, it can be difficult to perform this torque request conversion accurately. The difficulty of converting such torque requests is compounded by the dynamic nature of the requests. For example, since the torque demands received from the traction devices may vary with movement of the machine, the corresponding torque conversions must be responsive to such variations.

Known control systems typically perform such torque conversions using loss maps, look-up tables, or other known conversion strategies. For example, U.S. Pat. No. 6,385,970 to Kuras et al. discloses a system that includes an engine, a hydraulic CVT, and a control system in communication with the engine and the CVT. The control system of the '970 patent is paired with a hydro-mechanical drive system that is operable to sense engine speed and create an output speed signal. The control system is further operable to compare the engine speed signal to an underspeed value and produce an error signal. The error signal is used to produce a command signal that controls the transmission ratio to manage the load on the engine.

While the control system of the '970 patent may incorporate various strategies including the use of loss maps and/or look-up tables to convert torque demands received by the CVT into torque requests sent to the engine, such conversions are extremely complicated and cumbersome. For instance, typically four or five-dimensional loss maps are needed in order to perform such conversions accurately. However, such maps require a large amount of memory as well as a significant amount of processor capacity. As a result, using such maps can strain limited system resources and can reduce the overall efficiency of the machine. In fact, the requirements of some such loss maps can exceed the capabilities/capacity of conventional on-board control systems. To avoid this, conventional control systems may, instead, employ relatively low-resolution loss maps to perform the torque conversion described above. Due to the reduced computational accuracy associated with low-resolution loss maps, however, such control systems are not capable of optimizing the transmission of torque through the CVT.

The present disclosure is directed towards overcoming one or more of the problems as set forth above.

### SUMMARY OF THE INVENTION

In an exemplary embodiment of the present disclosure, a method of controlling a transmission associated with a machine includes determining a torque demand associated with a parasitic load, the parasitic load receiving power from a power source of the machine via the transmission. The method also includes converting the torque demand into a corresponding torque request using a first neural network associated with a control system of the machine. The torque demand is an input of the first neural network and the torque request is an output of the first neural network. The method further includes directing the power source to provide torque to the transmission substantially equal to the torque request.

In another exemplary embodiment of the present disclosure, a method of controlling a transmission associated with a machine includes determining a plurality of operating characteristics of the machine, and determining a torque demand indicative of torque required by a traction device receiving power from the power source via the transmission. The method also includes inputting data indicative of the plurality of operating characteristics and the torque demand into a first neural network associated with a control system of the machine. The method further includes converting the torque demand into a torque request, based on the data, using the first neural network. The torque request is indicative of an input torque required by the transmission in order for the transmission to generate an output torque substantially equal to the torque demand. The method also includes providing torque from the power source to the transmission substantially equal to the torque request.

In a further exemplary embodiment of the present disclosure, a machine includes a power source, a transmission operably connected to the power source, and a parasitic load receiving power from the power source via the transmission. The machine also includes a control system in communication with the power source, the transmission, and the parasitic load. The control system is operable to determine a torque demand associated with the parasitic load, and to convert the torque demand into a corresponding torque request using a first neural network associated with the control system. The torque demand is an input of the first neural network and the torque request is an output of the first neural network. The control system is also operable to direct the power source to provide torque to the transmission substantially equal to the torque request.

### BRIEF DESCRIPTION OF THE DRAWINGS

FIG. 1 is a schematic illustration of an exemplary embodiment of a transmission control system.

FIG. 2 is another schematic illustration of an exemplary embodiment of a control system.

FIG. 3 is a flow chart illustrating an exemplary method of operating a control system.

### DETAILED DESCRIPTION

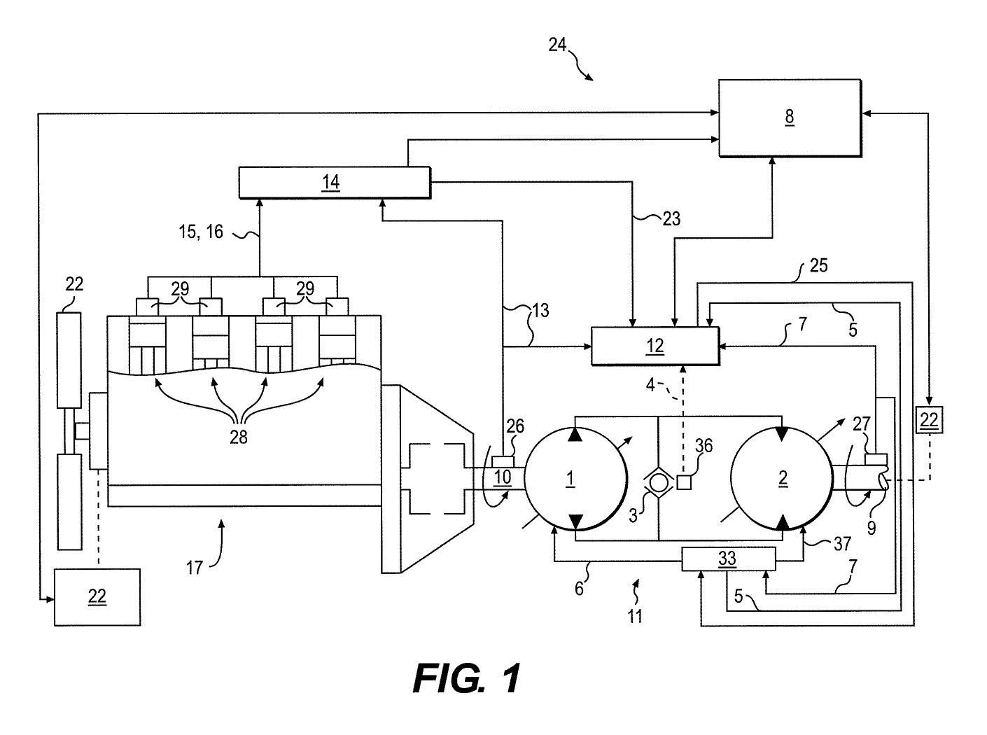

FIG. 1 illustrates an exemplary control system 24 of the present disclosure. The control system 24 may be used, for example, with a power source 17, a transmission 11, and/or one or more parasitic loads 22 associated with a machine (not shown). Such a machine may be, for example, any mobile or stationary machine used to perform work or other tasks. Such exemplary machines may include, but are not limited to, wheel loaders, motor graders, track-type tractors, excavators, power generators, on-highway vehicles, off-highway vehicles, and/or other like equipment. Such machines may be used to perform tasks in, for example, mining, excavating, construction, farming, transportation, and/or other like environments or applications.

In the exemplary embodiment of FIG. 1, the power source 17 is an engine, such as an internal combustion engine. The engine may be a diesel engine, a gasoline engine, a natural gas engine, or any other engine readily apparent to one skilled in the art. It is contemplated that the control system 24 may be used with other types of power sources such as, for example, fuel cells.

As illustrated in FIG. 1, the power source 17 may include a plurality of combustion chambers 28, and a fuel injector 29 may be associated with each combustion chamber 28. In the illustrated embodiment, the power source 17 includes four combustion chambers 28 and four associated fuel injectors 29. One skilled in the art will readily recognize, however, that power source 17 may include a greater or lesser number of combustion chambers 28, and that combustion chambers 28 may be disposed in an “in-line” configuration, a “V” configuration, or any other conventional configuration.

The power source 17 may be configured to provide an output torque to the transmission 11 and/or other components of the machine across a range of power source speeds. For example, the power source 17 may be configured to provide output torque to one or more components of the machine via the transmission 11. Such output torque may be transmitted from the power source 17 to transmission 11, and from the transmission 11 to such machine components, to assist in performing the various tasks described herein. For example, one or more of the parasitic loads 22 may receive power from the power source 17 via the transmission 11. Such parasitic loads 22 may include, for example, the wheels, tracks, and/or other traction devices of the machine. Such parasitic loads 22 may also include, for example, one or more hydraulic motors, pumps, cylinders, fans, and/or other machine components used in performing work. Such parasitic loads 22 may, for example, assist in maneuvering, accelerating, braking, and/or otherwise moving the machine during use. Such parasitic loads 22 may also, for example, assist in power source cooling as well as raising, lowering, turning, moving and/or otherwise operating one or more arms, booms, buckets, graders, augers, tools, implements, and/or other machine components.

With continued reference to FIG. 1, an input drive member such as, for example, a countershaft 10 may connect the power source 17 to the transmission 11 at an interface between the power source 17 and the transmission 11. The transmission 11 may also include an output driven member such as, for example, an output shaft 9. As described in greater detail below, the transmission 11 may convert an input rotation of countershaft 10 into an output rotation of output shaft 9. In this manner, power and/or torque generated by the power source 17 may be transmitted to the output shaft 9, and the output shaft 9 may transmit such power and/or torque to one or more parasitic loads 22, such as the various traction devices of the machine.

In additional exemplary embodiments, the transmission 11 may be configured to provide an input rotation of the countershaft 10 to the power source 17, thereby transmitting input power and/or torque to the power source 17. In exemplary embodiments, such input power and/or torque provided to the power source 17 by the transmission 11 may be used to assist in braking the machine. It is understood that the transmission 11 may comprise any known type of transmission, and in some exemplary embodiments, such as embodiments in which the transmission 11 is configured to provide power and/or torque to the power source 17, the transmission 11 may comprise a CVT. As shown in FIG. 1, the transmission 11 may be a hydraulic CVT. Alternatively, in additional exemplary embodiments, the transmission 11 may be an electric CVT or other type of CVT apparent to one skilled in the art.

A CVT generally consists of a driving element, a driven element, and a ratio controller 33. In the hydraulic CVT illustrated in FIG. 1, the driving element may be a pump 1, such as a variable displacement pump, and the driven element may be a motor 2, such as a variable displacement motor. In an electric CVT, on the other hand, the driving element may be an electric generator and the driven element may be an electric motor.

In the hydraulic CVT of FIG. 1, the ratio controller 33 may be configured to manipulate the displacement of the pump 1 with a pump command signal 6, and may be configured to manipulate the displacement of the motor 2 with a motor command signal 37. By manipulating displacements in this way, the ratio controller 33 may vary and/or otherwise control the output rotation of output shaft 9. The motor 2 may be fluidly connected to the pump 1 by conduits that supply and return fluid to and from the pump 1 and motor 2. As a result, the pump 1 may be configured to drive the motor 2 by fluid pressure. The transmission 11 may also include a resolver 3, allowing for a measurement of a pressure differential between the two conduits of supply and return fluid. The pressure differential between the two conduits and/or the displacement of the motor 2 may be used to determine an output torque of the transmission 11.

The ratio controller 33 may also be configured to control the ratio of the transmission output speed to the transmission input speed. In the exemplary embodiment shown in FIG. 1, the ratio controller 33 may be in communication with both the driving element and the driven element, and may adjust the ratio of the transmission output speed to the transmission input speed, as limited by the power output of the power source 17. When both output torque and output speed increases are demanded of the transmission 11, a demand for increased power is transmitted to the power source 17 by the ratio controller 33. Likewise, when both output torque and output speed decreases are demanded of the transmission 11, a demand for decreased power is transmitted to the power source 17.

The ratio of transmission output speed to transmission input speed (referred to herein as the “speed ratio” of the transmission 11), at a particular power source output power, may be controlled by manipulating the displacement of the pump 1 and motor 2. As the machine encounters a relatively rapid change in loading conditions such as, for example, a change from a high ground speed with a low load to a low ground speed with a high load, the ratio controller 33 may shift the ratio of the transmission 11 from a high speed output to a low speed output. It is understood that such a relatively rapid change in loading conditions may occur, for example, upon driving the machine into a pile of material with an empty bucket, lifting the bucket loaded with material, and backing the machine away from the pile of material in a reverse direction. When shifting from a high speed output to a low speed output, the ratio controller 33 may decrease the flow of fluid supplied to the motor 2 by decreasing the displacement of the pump 1 to reduce the torque load or power load of the power source 17. The ratio controller 33 may also increase the displacement of the motor 2 to decrease the load on the power source 17. If the machine encounters a reduction in load, the ratio controller 33 may increase the displacement of the pump 1 and may decrease the displacement of the motor 2. The increased displacement of the pump 1 combined with the decreased displacement of the motor 2 results in an increase in machine travel speed and a reduction in the available torque.

Alternatively, in an electric CVT, the ratio of transmission output speed to input speed, at a particular power source output power, may be controlled by manipulating a torque command signal to the electric motor described above. As the machine encounters a relatively rapid change in loading conditions such as, for example, changing from a high ground speed with a low load to a low ground speed with a high load, the ratio controller 33 may alter the torque command signal sent to the electric motor to produce additional torque. In turn, the electric motor may demand additional power capacity from the generator described above in the form of additional current.

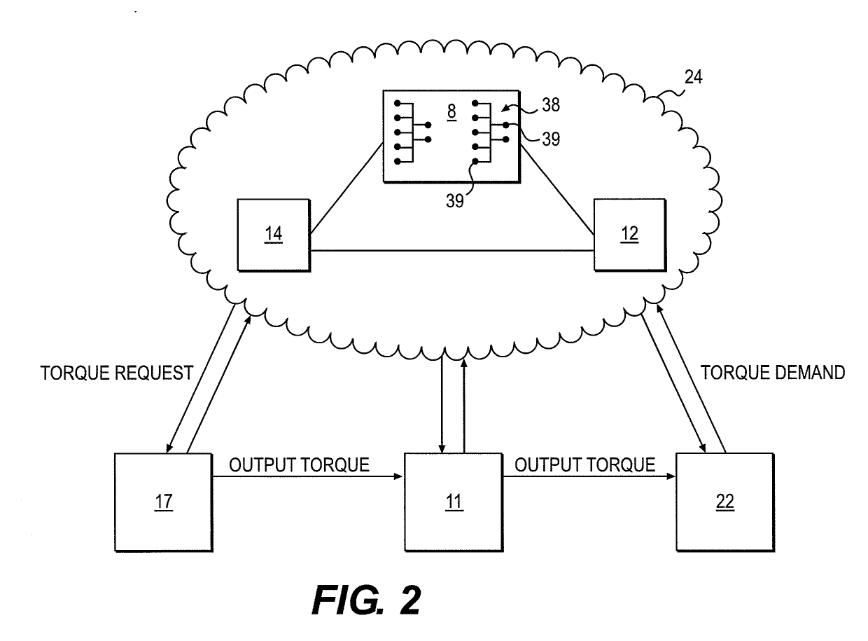

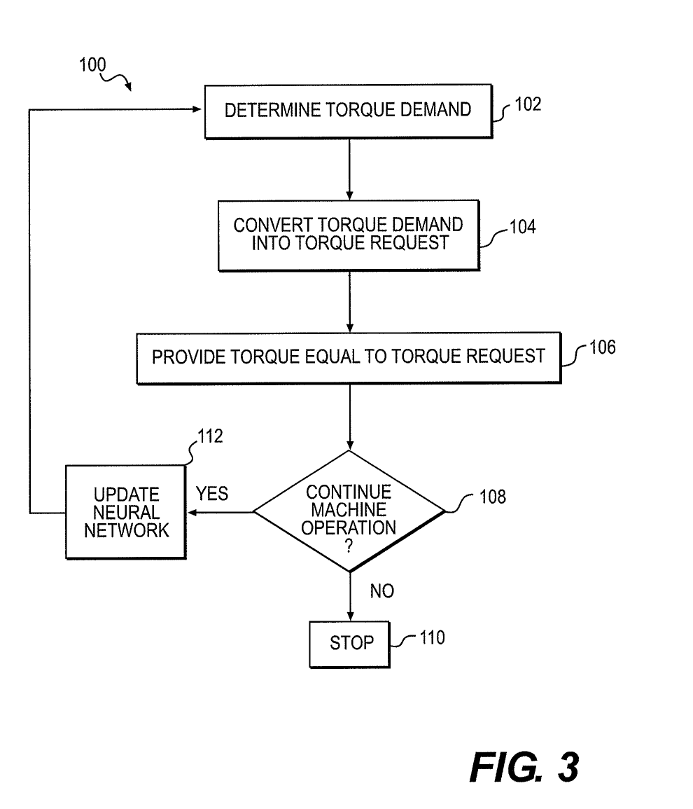

As shown schematically in FIG. 2, the output torque provided by the transmission 11 to a parasitic load 22 may be responsively and/or otherwise adaptively controlled based on a torque demand received from the parasitic load 22. As used herein, the term “torque demand” may be defined as and/or may otherwise be indicative of, for example, a torque required by the parasitic load 22 to perform a desired task. In order to provide an output torque sufficient to satisfy such a torque demand, one or more components of the control system 24 must convert the torque demand into a torque request that can be used to control the output torque of the power source 17. As used herein, the term “torque request” may be defined as and/or may otherwise be indicative of, for example, a torque required by the transmission 11 in order for the transmission 11 to generate an output torque equal to a corresponding torque demand. Such a torque request may be employed by the control system 24 to direct and/or otherwise control operation of the power source 17. For example, the power source 17 may be directed to generate an output torque sufficient to satisfy the torque request. However, it may be difficult to perform such torque conversions accurately using traditional loss maps, look-up tables, or other conventional means due to the complex nature of CVTs and other transmissions 11, and the highly-nonlinear transmission of torque therethrough. Such conversions may be particularly difficult when the output speed of the transmission 11 passes close to or through zero, such as during a transition from machine braking to machine propulsion. Exemplary methods of performing such conversions will be described in greater detail below with reference to FIGS. 2 and 3.

As shown in FIG. 1, one or more sensors may be associated with the transmission 11, the power source 17, and/or the parasitic loads 22. These sensors may be configured to generate signals indicative of one or more operating characteristics of the machine, and such operating characteristics may be associated with, for example, the transmission 11, the power source 17, and/or the parasitic loads 22, respectively. For example, in the hydraulic transmission 11 of FIG. 1, a pressure sensor 36 may be configured to provide a fluid pressure signal 4 from the resolver 3 to a transmission controller 12 associated with the control system 24. In addition, a power source speed sensor 26 may be configured to produce a power source speed signal 13, and a transmission speed sensor 27 may be configured to produce a transmission speed signal 7. The speed sensors 26, 27 may be, for example, in the form of magnetic pick-up sensors configured to produce signals corresponding to the rotational speeds of the countershaft 10 and the output shaft 9, respectively. These sensors 26, 27 may also be capable of determining the angular position and/or direction of rotation of the countershaft 10 and output shaft 9. The speed sensors 26, 27 may provide the respective signals to the transmission controller 12 and/or to a power source observer 14 associated with the control system 24. Additionally, although not illustrated in FIG. 1, in exemplary embodiments of the present disclosure one or more sensors associated with the machine may be configured to determine operating characteristics including, for example, a transmission gear, the speed ratio of the transmission 11, a travel direction of the machine, and/or other like operating characteristics. Such additional sensors may comprise, for example, a throttle position sensor, a position sensor associated with a forward-neutral-reverse lever of the machine, and/or other like sensors associated with the machine and/or operator interfaces thereof.

The power source observer 14 and the transmission controller 12 may be operably connected and/or otherwise in communication with each other. Additionally, the transmission controller 12 and the power source observer 14 may be operably connected to and/or otherwise in communication with a machine controller 8 of the control system 24. Although FIG. 1 illustrates the transmission controller 12, the power source observer 14, and the machine controller 8 as being separate components of the control system 24, in additional exemplary embodiments, the transmission controller 12, the power source observer 14, and/or the machine controller 8 may be combined into and/or may otherwise embody a single controller, microprocessor, and/or other known control component. Numerous commercially available microprocessors can be configured to perform the functions of the controller 12, the power source observer 14, and the machine controller 8. One or more of the controller 12, the power source observer 14, and the machine controller 8 may comprise memory and/or other storage components configured to retain data maps, look-up tables, algorithms, programs, sensed operating characteristics, and/or other information used to operate the machine and/or the control system 24. In addition, as will be described in greater detail below with respect to FIG. 2, one or more components of the control system 24 may include one or more neural networks 38 configured to assist in controlling the transmission 11, the power source 17, and/or the parasitic loads 22.

In exemplary embodiments, the control system 24 may use observed and/or otherwise determined operating characteristics, and/or signals received from one or more of the sensors described herein, to determine one or more parameters associated with the transmission 11, the power source 17, the parasitic loads 22, and/or the machine. Such parameters may include but are not limited to, for example, an output torque generated by the power source 17, an output torque generated by the transmission 11, a torque demand from one or more of the parasitic loads 22, a torque request associated with the power source 17, and a power loss associated with the transmission 11. The power source output torque, transmission output torque, torque demand, torque request, transmission power loss, and/or other machine parameters described herein may be determined in an open-loop or a closed-loop manner by the control system 24. Such parameters may be used to assist in, for example, maneuvering the machine, operating the parasitic loads 22, and/or otherwise controlling the transmission 11, the power source 17, the parasitic loads 22, and/or other machine components.

The power source observer 14 may be configured to monitor one or more operating characteristics of the power source 17 and/or to receive signals indicative of one or more such operating characteristics. For example, the power source observer 14 may receive the power source speed signal 13 described above with respect to power source speed sensor 26. In addition, the power source observer 14 may monitor the operation of the fuel injectors 29 through a power source fuel setting signal 15 and a power source fuel injection timing signal 16. Such signals may be provided to the power source observer 14 via one or more sensors (not shown) associated with the fuel injectors 29. In exemplary embodiments, the power source observer 14 may use one or more such inputs to estimate, calculate, and/or otherwise determine the output torque generated by the power source 17. In exemplary embodiments, the output torque of the power source 17 may also be determined based on, among other things, ambient temperature, ambient humidity, power source load, machine travel speed, and/or other known parameters. The determined power source torque may be sent to the transmission controller 12 via a torque signal 23. Additionally, the power source speed, power source torque, and or other operating characteristics or determined parameters may be sent from the power source observer 14 to the machine controller 8. It is understood that signals, data, and/or information indicative of the operating conditions and machine parameters described herein may be communicated between the power source observer 14, the transmission controller 12 and the machine controller 8 wirelessly and/or via one or more known connections.

The transmission controller 12 may be configured to monitor any of the operating characteristics described herein and/or to receive signals indicative of one or more operating characteristics of the transmission 11 and/or the parasitic loads 22. For example, the transmission controller 12 may be configured to receive inputs including the transmission speed signal 7 from speed sensor 27, a pump and motor displacement signal 5 from ratio controller 33, and the fluid pressure signal 4 from pressure sensor 36. The transmission controller 12 may also receive the power source speed signal 13 discussed above with respect to the power source speed sensor 26, and the torque signal 23 generated by the power source observer 14. In exemplary embodiments in which the transmission 11 comprises an electric CVT, the transmission controller 12 may also be configured to receive inputs including, for example, a torque command signal from ratio controller 33, and the transmission speed signal 7 from transmission speed sensor 27. The transmission controller 12 may determine one or more parameters of the machine, the parasitic loads 22, and/or the transmission 11 based on such inputs, and may generate one or more control commands based on the determined parameters. For example, the transmission controller 12 may determine an output torque of the transmission 11 exerted on countershaft 10, through one or more torque algorithms, using the pump and motor displacement signal 5, the fluid pressure signal 4, the power source speed signal 13, and/or the torque signal 23 as algorithm inputs. In additional exemplary embodiments, any of the neural networks 38 described herein may be employed to determine the output torque of the transmission 11 and/or the output torque of the power source 17.

With continued reference to FIG. 1, the machine controller 8 may be configured to monitor any of the operating characteristics described herein and/or to receive signals indicative of one or more operating characteristics of the transmission 11, the power source 17, and/or the parasitic loads 22. For example, the machine controller 8 may be configured to receive inputs including the transmission speed signal 7 from speed sensor 27 and/or from the transmission controller 12. The machine controller 8 may also receive a signal generated by the transmission controller 12 indicative of the transmission output torque. In addition, the machine controller 8 may receive one or more signals generated by the power source observer 14. Such signals may be indicative of, for example, the power source output torque and/or the power source speed. In further exemplary embodiments, the machine controller 8 may receive the power source speed signal 13 from the power source speed sensor 26. In addition, the machine controller 8 may receive one or more signals from the respective parasitic loads 22 and/or sensors associated with the parasitic loads 22. Such signals may contain information indicative of, for example, a fluid pressure, a load, and/or a torque demand associated with the respective parasitic load 22. For example, the machine controller 8 may be in communication with one or more of the parasitic loads 22, and may receive a respective torque demand from each parasitic load 22. The machine controller 8 may also receive signals indicative of, for example, the speed ratio of the transmission 11, a gear of the transmission, a travel direction of the machine, and/or any of the other operating characteristics described herein.

The machine controller 8 may determine one or more parameters of the machine, the parasitic loads 22, the power source 17, and/or the transmission 11 based on such inputs, and may generate one or more control commands based on the determined parameters. For example, the machine controller 8 may determine a cumulative torque demand based on each of the respective torque demands received from the parasitic loads 22. Such a cumulative torque demand may be a sum of such individual respective torque demands. Such torque demands may be received from, for example, sensors associated with the one or more traction devices of the machine.

In exemplary embodiments, the control system 24 may be configured to determine a torque request based on a corresponding torque demand. For example, the machine controller 8 and/or the transmission controller 12 may comprise one or more neural networks 38 configured to assist in converting a torque demand into a corresponding torque request. For purposes of illustration, such exemplary neural networks 38 are shown schematically in FIG. 2 with respect to machine controller 8. FIG. 2 also illustrates that each of the transmission 11, the power source 17, and the parasitic loads 22 may be in communication with the control system 24 and/or with the one or more neural networks 38 employed by the components of the control system 24. In such exemplary embodiments, the torque demand may comprise an input of a neural network 38 and the torque request may comprise an output of the neural network 38. The neural network 38 may comprise, for example, a cascaded neural network, a back propagation neural network, and/or any other type of neural network known in the art. The neural network 38 may be configured to solve for one or more machine parameters or other like output variables based on various learned control relationships. For example, such a neural network 38 may utilize a set of inputs, in combination with inputs accumulated during a learning period, to create one or more rules for controlling the machine and/or components of the machine in future operations.

In an exemplary embodiment, one or more of the neural networks 38 employed by the control system 24 may comprise at least one node 39 or other like processing element. Such nodes 39 may be arranged in one or more layers of the neural network 38, and the nodes 39 employed by the neural network 38 may be interconnected between and/or across the various network layers. Arranging the nodes 39 in this way may assist the neural network 38 in, for example, solving for nonlinear variables such as the torque request, transmission loss, and/or other machine parameters described herein. In exemplary embodiments, each node 39 may be capable of generating an output signal determined by a weighted sum of input signals received by the neural network 38 and one or more threshold values specific to the respective node 39. For example, a node 39 may be provided with an input such as data indicative of an operating characteristic of the machine. In exemplary embodiments, data indicative of a plurality of operating characteristics may be separately inputted into respective nodes 39. The exemplary nodes 39 of the present disclosure may use such inputs to calculate and/or otherwise determine, in an open-loop or closed-loop manner, a linear or nonlinear output. Such an output may be limited, governed, and/or otherwise modified according to the respective threshold value associated with the node 39. Additionally, such an output may be provided to other linked nodes 39 of the neural network 38, to nodes 39 of an additional neural network 39 employed by the control system 24, or to a component of the control system 24 outside of the one or more neural networks 38.

In exemplary embodiments, one or more of the nodes 39 described herein may be weighted, either positively or negatively, by a weigh bias. As used herein, the term “weight bias” may be defined as a gain factor and/or other like value or term assisting in governing the priority and/or effect allocated to a respective input provided to the associated node 39. In exemplary embodiments, one or more weight biases of the neural network 38, as well as the threshold values described above, may be derived during the neural network learning period. In such a learning period, the neural network 38 may be “taught” by providing it with a succession of input patterns and corresponding expected output patterns associated with a given system. The neural network 38 may “learn” by, for example, measuring the difference, at each output node 39, between the expected output pattern and the actual output produced by the neural network 38. In exemplary embodiments, the weight biases and threshold values may be modified and/or otherwise updated by one or more learning algorithms employed by the control system 24. Such updating may assist in producing an output which more closely approximates the expected output pattern, while minimizing the error over the spectrum of neural network inputs. Through this learning process, the neural network 38 may be taught during the learning period as well as during use of the machine in the various operations described herein. For example, one or more components of the neural network 38, such as the weigh biases associated with the respective nodes 39, may be updated during use and after such an initial learning period. In exemplary embodiments, the weight biases and/or other components of the neural network 38 may be updated, in an open-loop manner or in a closed-loop manner, and the updated neural network 38 may be used in subsequent operations. In such exemplary embodiments, a weight bias and/or other component of the neural network 38 may be updated based on a torque request and/or other neural network inputs or outputs, and the updated neural network 38 may be used to convert an additional torque demand into a corresponding additional torque request.

### INDUSTRIAL APPLICABILITY

The disclosed systems and methods have wide applications in a variety of machines including, for example, wheel loaders and track-type tractors. The disclosed systems and methods may be implemented into any machine that utilizes a transmission to convert rotational speed of a power source into a drive speed for a traction device. For example, the disclosed systems and methods may be used by any machine employing a power source, a CVT, and/or one or more parasitic loads. Such parasitic loads may receive power from the power source in order to perform a variety of tasks, and may be operable to assist in machine propulsion and braking.

During an exemplary machine operation, it may be necessary to move the machine from a first location to a second location, to move one or more implements associated with the machine, and/or to operate one or more of the parasitic loads 22 of the machine. As shown in the flow chart 100 of FIG. 3, during such exemplary operations, a method of controlling operation of the transmission 11, the power source 17, and/or the parasitic loads 22 may include determining a torque demand associated with at least one of the parasitic loads 22 (Step: 102). In an exemplary control method, the various sensors described herein may substantially continuously sense, detect, calculate, observe, and/or otherwise determine respective operating characteristics of the machine. As noted above, such operating characteristics may include, among other things, power source speed, transmission speed, fluid pressure, transmission gear, transmission speed ratio, machine travel direction, and implement load. The sensors may substantially continuously send signals indicative of such operating characteristics to one or more of the machine controller 8, the transmission controller 12, and the power source observer 14, and these components of the control system 24 may determine one or more machine parameters, such as torque demand, using the information contained in such signals as inputs.

For example, an operator of the machine may depress a throttle pedal of the machine, manipulate a forward-neutral-reverse selector of the machine, and/or otherwise manipulate any of the other operator interfaces described herein, and such manipulation may be indicative of an operator desire or command to move the machine. One or more of the sensors described herein, such as a throttle pedal position sensor, a forward-neutral-reverse selector position sensor, a hydraulic pressure sensor associated with a traction device, and/or any other like sensor may detect and/or measure such manipulation. The sensor may send a signal indicative of the sensed manipulation to the control system 24, and one or more components of the control system 24 may determine a corresponding torque demand associated with a traction device of the machine. Such a torque demand may be indicative of, for example, the torque required by the traction device to satisfy the operator's machine movement command.

At Step: 104 the machine controller 8 and/or the transmission controller 12 may convert the torque demand determined at Step: 102 into a corresponding torque request. In exemplary embodiments, the torque demand determined at Step: 102 may comprise an input of a first neural network 38 and the torque request may comprise an output of the first neural network 38. In further exemplary embodiments, data indicative of one or more machine operating characteristics may also be entered and/or otherwise inputted into the first neural network 38 associated with the control system 24. In such embodiments, the torque demand may be converted into the corresponding torque request, based on the inputted data, using the first neural network 38. It is understood that the torque request determined at Step: 104 may be indicative of an input torque required by the transmission 11 (i.e., an input torque that the transmission 11 must receive from the power source 17) in order for the transmission 11 to generate an output torque equal to the torque demand determined at Step: 102. It is further understood that a plurality of the operating characteristics described herein may be inputted into the first neural network at Step: 104, and that the torque demand may be converted into the torque request based on at least one such additional neural network input. For example, data indicative of each respective operating characteristic may each be inputted into a respective node 39 of the first neural network 38. The torque demand may be converted into the torque request at Step: 104 based on the data inputted at the respective nodes 39. It is understood that the conversions occurring at Step: 104 may proceed in accordance with the learned rules, control relationships, and/or other operating parameters described herein with the neural network 38 and the various nodes 39. For example, information, values, and/or other data indicative of the torque demand and the various operating characteristics inputted into the neural network 38 may pass between linked nodes 39 and/or between various layers of the neural network 38. As part of the, weight biases, threshold values, and/or other parameters associated with the respective nodes 39 may be used to calculate and/or otherwise determine a torque request corresponding to the torque demand.

While the torque request determined at Step: 104 may comprise an output of the first neural network 38, in additional exemplary embodiments, the first neural network 38 may be configured to generate one or more additional outputs. For example, the neural network 38 may determine, in a closed loop manner, a power loss of the transmission 11. As used herein, the term “power loss” may be defined as a percentage, value, and/or other like output quantifying and/or otherwise characterizing performance of the transmission 11 as the transmission receives output torque provided by the power source 17. For example, such a power loss may be descriptive of friction and/or other losses associated with transmitting torque from the countershaft 10 (i.e., from the power source 17) to the output shaft 9 and/or other output of the transmission 11. Such power loss may be attributed to, for example, operation of the various gears, linkages, pumps 1, motors 2, resolvers 3, and/or other components of the transmission 11. Such power losses may be determined by the first neural network, in a closed-loop manner, at Step: 104 as each torque demand is converted to a corresponding torque request.

Once the torque request has been determined at Step: 104, the machine controller 8 may direct the power source 17 to provide torque to the transmission 11 corresponding to the torque request. For example, at Step: 106, the machine controller 8 may direct the power source 17 to generate an output at the countershaft 10 corresponding to, related to, and/or as a function of the torque request generated at Step: 104. In exemplary embodiments, the machine controller 8 may direct the power source 17 to generate an output substantially equal to the torque request generated at Step: 104. For example, the power source 17 may rotate the countershaft 10 at a speed enabling the countershaft 10 to deliver an output torque to the transmission 11 that is substantially equal to the torque request. In such exemplary embodiments, the output torque delivered to the transmission 11 by the countershaft 10 may be equal to the torque request. The rotation of the countershaft 10 and/or other output of the power source 17 may have the effect of increasing or decreasing a speed of the power source 17. In addition, the rotation of the countershaft 10 and/or other output of the power source 17 may have the effect of increasing or decreasing the travel speed of the machine. The effect of delivering an output torque to the transmission 11 that is substantially equal to the torque request may assist in enabling the transmission 11 to provide output torque to the parasitic loads 22 sufficient to satisfy the torque demand. A shown schematically in FIG. 2, such output torque may be transmitted from the power source 17 to the transmission 11, and the transmission 11 may responsively transmit a corresponding output torque to one or more parasitic loads 22 including a traction device of the machine.

Control of the transmission 11, power source 17, and/or parasitic loads 22 described herein may continue in a closed-loop manner, in accordance with the methods illustrated in flow chart 100, until machine operation is no longer required. For example, at Step: 108 the machine controller 8 may determine whether continued machine operation is required. Such a determination may be made based on, for example, the receipt of continued torque demands, sensing additional operator commands indicative of machine acceleration or deceleration, a continued or increased implement load, and/or any of the other operating characteristics described herein. If the machine controller 8 determines that continued machine operation is not required (Step: 108—No), control of the various machine components in accordance with the exemplary methods described herein with respect to FIG. 3 may cease (Step: 110).

Alternatively, if the machine controller 8 determines that continued machine operation is required (Step: 108—Yes), control may proceed to Step: 112 where at least one component of the neural network 38 may be updated. For example, one or more components of the neural network 38, such as a weight bias associated with at least one node 39 of the neural network 38 may be updated at Step: 112, in a closed-loop manner. In still further exemplary embodiments, one or more of the threshold values associated with a node 39 may also be updated at Step: 112. It is understood that, in exemplary embodiments, operating characteristics or machine parameters may comprise inputs to the neural network 38 useful in converting the torque demand into the torque request (Step: 104) and/or in updating the neural network (Step: 112). For example, the machine controller 8 may use one or more of power source speed, power source torque, the torque request determined at Step: 104, and/or other operating characteristics or machine parameters as inputs into one or more weight bias updating algorithms at Step: 112. Such algorithms may generate respective modified weight bias values as outputs, and such modified weight bias values may be determined, in a closed-loop manner, to reduce and/or substantially eliminate transmission power loss. As a result of such adaptive and/or otherwise responsive weight bias updates, output torque provided by the power source 17 may be optimized during machine operation.

Upon updating the neural network 38 at Step: 112, control may return to Step: 102, in a closed-loop manner, where an additional torque demand associated with the one or more parasitic loads 22 may be determined. The machine controller 8 may convert the additional torque demand into a corresponding additional torque request using the updated neural network 38. For example, at Step: 104 the one or more components of the neural network 38 updated at Step: 112 may be used to convert the additional torque demand into the additional torque request. Such closed-loop control and/or neural network updating may continue until, for example, the machine controller determines at Step: 108 that continued machine operation is no longer required.

As described above, in exemplary embodiments more than one neural network 38 may be employed by the control system 24 for controlling the various components of the machine. For example, in additional embodiments a second neural network 38 may be employed concurrently with the first neural network 38 described above for controlling the power source 17, the transmission 11, and/or the various parasitic loads 22. In such exemplary embodiments, one or more nodes 39 of the first neural network 38 may be interconnected with and/or otherwise in communication with one or more corresponding nodes 39 of the second neural network 38. Moreover, one or more outputs of the first neural network 38 may be directed to the second neural network 38 and/or may otherwise comprise inputs of the second neural network 38. Likewise, one or more outputs of the second neural network 38 may be directed to the first neural network 38 and/or may otherwise comprise inputs of the first neural network 38. It is further understood that one or more of the various neural networks 38 described herein may be used either independently and/or in combination for controlling components of the machine.

In an exemplary embodiment, any of the operating characteristics and/or machine parameters described herein may comprise inputs to a second neural network 38. For example, control methods of the present disclosure may include determining a first torque value representative of output torque provided to the transmission 11 by the power source 17. Such a first torque value may be determined by, for example, the machine controller 8 and/or the transmission controller 12 using operating characteristics such as, for example, power source speed and/or transmission speed as inputs. The second neural network 38 may then convert this first torque value into a corresponding second torque value representative of output torque provided by the transmission 11. Such transmission output torque may be provided by, for example, the output shaft 9 of the transmission 11 and/or any other like output thereof. In exemplary embodiments, the first torque value described above may comprise an input of the second neural network 38 and the second torque value may comprise an output of the second neural network 38.

In exemplary embodiments employing a second neural network 38, a second torque value determined by the second neural network 38 may be representative of output torque provided by the transmission 11 in response to receiving output torque from the power source 17, and such output torque received from the power source 17 may correspond to and/or be equal to the first torque value. In additional exemplary embodiments, the second torque value determined by the second neural network may be based on and/or representative of a torque request and/or other output of the first neural network 38. Moreover, in such exemplary embodiments the second neural network 38 may be updated, in a closed-loop manner, as described above with respect to Step: 112. For example, exemplary control methods employing a second neural network 38 may include updating the second neural network 38, in a closed-loop manner, based on the second torque value determined by the second neural network 38. Upon updating the second neural network 38, control may, for example, proceed to Step: 102 where a third torque value representative of torque provided to the transmission 11 by the power source 17 may be determined. The machine controller 8 may convert the third torque value into a corresponding fourth torque value, in a closed-loop manner, using the updated second neural network. As described above with respect to Step: 108, control may proceed in this manner until the control system 24 determines that continued machine operation is no longer required.

By providing torque to the traction devices and/or other parasitic loads 22 using an adaptive neural network 38 that is updated, in a closed loop manner, during operation, embodiments of the present disclosure may improve the operational efficiency of the machine. For example, converting a traction device torque demand into a corresponding torque request using a neural network, in a closed-loop manner, and providing torque from the power source 17 to the transmission 11 based on the torque request may result in an accurate distribution of torque to the traction device. Such accurate torque distribution may ensure that parasitic torque demands are satisfied across a range of operating conditions. In particular, using a neural network to perform such torque conversion may enhance power source and/or transmission response during conditions in which the transmission 11 is operating with an output speed near zero.

Using one or more neural networks 38 to adaptively convert torque demands into torque requests may be advantageous over known loss map/look-up table control methods since neural networks perform far less complicated calculations than such known methods. As a result, neural networks require less memory and less processor capacity than known loss map/look-up table control systems, and are generally more responsive to dynamic multi-variable systems like the transmission 11 described herein. Additionally, known loss map/look-up table control systems are not be capable of modifying and/or otherwise updating weight biases and/or other system components during use. As a result, operation of the corresponding parasitic loads may not be optimized while performing various operations.

Other exemplary embodiments of the present disclosure will be apparent to those skilled in the art from consideration of the specification, and practice of the systems and methods disclosed herein. It is intended that the specification and examples be considered as exemplary only, with a true scope of the invention being indicated by the following claims.

What is claimed is:

1. A method of controlling a transmission associated with a machine, comprising:
determining a torque demand associated with a parasitic load, the parasitic load receiving power from a power source of the machine via the transmission;
converting the torque demand into a corresponding torque request using a first neural network associated with a control system of the machine, wherein the torque demand comprises an input of the first neural network and the torque request comprises an output of the first neural network; and
directing the power source to provide torque to the transmission substantially equal to the torque request.

2. The method of claim 1, further including determining an operating characteristic of at least one of the transmission, the power source, and the parasitic load, and converting the torque demand into the torque request based on the operating characteristic, wherein the operating characteristic comprises an additional input of the first neural network.

3. The method of claim 2, wherein the operating characteristic comprises one of power source speed, transmission speed, transmission gear, transmission speed ratio, and machine travel direction.

4. The method of claim 1, further including updating at least one component of the first neural network based on the torque request.

5. The method of claim 4, further including determining an additional torque demand associated with the parasitic load, and converting the additional torque demand into a corresponding additional torque request using the updated at least one component of the first neural network.

6. The method of claim 4, wherein the at least one component comprises a weight bias associated with a node of the first neural network.

7. The method of claim 1, wherein converting the torque demand into the torque request further includes determining, with the first neural network, a power loss of the transmission, the power loss characterizing performance of the transmission as the transmission receives torque provided by the power source.

8. The method of claim 1, further including determining a first torque value representative of torque provided to the transmission by the power source, and converting the first torque value into a corresponding second torque value using a second neural network associated with the control system, wherein the first torque value comprises an input of the second neural network and the second torque value comprises an output of the second neural network, the second torque value being representative of torque provided by the transmission in response to receiving torque from the power source substantially equal to the first torque value.

9. A method of controlling a transmission associated with a machine, comprising:
determining a plurality of operating characteristics of the machine;
determining a torque demand indicative of torque required by a traction device receiving power from the power source via the transmission;
inputting data indicative of the plurality of operating characteristics and the torque demand into a first neural network associated with a control system of the machine;
converting the torque demand into a torque request, based on the data, using the first neural network, the torque request being indicative of an input torque required by the transmission in order for the transmission to generate an output torque substantially equal to the torque demand; and
providing torque from the power source to the transmission substantially equal to the torque request.

10. The method of claim 9, further including converting at least one additional torque demand indicative of torque required by the traction device into at least one additional torque request, in a closed-loop manner, using the first neural network.

11. The method of claim 10, further including updating the first neural network based on the torque request, wherein the at least one additional torque demand is converted into the at least one additional torque request using the updated first neural network.

12. The method of claim 9, wherein converting the torque demand into the torque request further includes determining, with the first neural network, a power loss of the transmission, the power loss characterizing performance of the transmission as the transmission receives torque provided by the power source.

13. The method of claim 9, further including determining a first torque value representative of torque provided to the transmission by the power source, and converting the first torque value into a corresponding second torque value using a second neural network associated with the control system, wherein the first torque value comprises an input of the second neural network and the second torque value comprises an output of the second neural network, the second torque value being representative of torque provided by the transmission in response to receiving torque from the power source substantially equal to the first torque value.

14. The method of claim 13, further including updating the second neural network based on the second torque value;
determining a third torque value representative of torque provided to the transmission by the power source; and
converting the third torque value into a corresponding fourth torque value, in a closed-loop manner, using the updated second neural network.

15. The method of claim 9, wherein the first neural network comprises a plurality of nodes, the method further including inputting data indicative of each respective operating characteristic of the plurality of operating characteristics into a respective node of the plurality of nodes.

16. The method of claim 15, further including updating a weight bias associated with at least one node of the plurality of nodes based on the torque request.

17. A machine, comprising:
a power source;
a transmission operably connected to the power source;
a parasitic load receiving power from the power source via the transmission; and
a control system in communication with the power source, the transmission, and the parasitic load, wherein the control system is operable to
determine a torque demand associated with the parasitic load;
convert the torque demand into a corresponding torque request using a first neural network associated with the control system, wherein the torque demand comprises an input of the first neural network and the torque request comprises an output of the first neural network; and
direct the power source to provide torque to the transmission substantially equal to the torque request.

18. The machine of claim 17, wherein the parasitic load comprises a traction device of the machine.

19. The machine of claim 17, wherein the power source comprises a diesel engine, and the transmission comprises one of an electric continuously variable transmission and a hydraulic continuously variable transmission, the system further including at least one sensor configured to determine an operating characteristic of the diesel engine and to direct a signal indicative of the operating characteristic to the control system.

20. The machine of claim 19, wherein the torque demand is converted into the torque request, using the first neural network, based on the signal.
